(19) United States
(12) Patent Application Publication
(10) Pub. No.: US 2006/0127837 A1
(43) Pub. Date: Jun. 15, 2006

(54) Dental bleaching using regenerative ionophoresis

(75) Inventors: Bao Luu Nguyen, Diamond Bar, CA (US); Liet Hong Nguyen, Garden Grove, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Novocal, LLC

(21) Appl. No.: 11/301,471

(22) Filed: Dec. 12, 2005

Related U.S. Application Data
(60) Provisional application No. 60/635,415, filed on Dec. 13, 2004.
(60) Provisional application No. 60/654,045, filed on Feb. 18, 2005.

(51) Int. Cl. A61C 3/00

(52) U.S. Cl. 433/29; 433/215

(57) ABSTRACT

An embodiment of the present invention is a technique for dental bleaching. A tray covers teeth of a user and has a reservoir. A conductor is placed inside the tray. The conductor is covered by a bleaching agent when the bleaching agent fills the reservoir. The conductor is electrically connected to a negative terminal of a power source to cause regeneration of free radicals decomposed from the bleaching agent when power is applied.

### RELATED APPLICATIONS

This patent application claims the benefits of (1) US Provisional Application, titled “Intra-oral light”, Ser. No. 60/635,415, filing date: Dec. 13, 2004, and (2) US Provisional Application, titled “Intra-oral Light”, Ser. No. 60/654,045, filing date: Feb. 18, 2005.

### BACKGROUND

1. Field of the Invention

Embodiments of the invention relate to the field of dental cosmetics, and more specifically, to dental bleaching.

2. Description of Related Art

Dental bleaching, commonly known as teeth whitening, is a process to remove the discoloration on the tooth surface due to natural or acquired coloration. The process essentially involves using a chemical agent to break down the chromogenic macro molecules responsible for the discoloration.

Existing techniques for dental bleaching have a number of disadvantages. One technique uses a strip of material applied to the surface of the teeth with a tooth whitening substance. This technique is not efficient, requiring the user to wear the strip 30 minutes to 60 minutes once a day for 7 to 28 days. Another technique uses ultrasonic transducers to accelerate the chemical reactions between a peroxide and a dental bleach constituent. This technique is expensive and inconvenient, usually requiring the supervision of a dentist at the dental office. Other techniques utilize light emitting devices placed externally to the user's mouth. These techniques do not provide efficient bleaching, usually requiring the user to use the assembly for several days or for an extended period of time, either at home or at the dentist's office, to achieve the desired bleaching of the discoloration.

### BRIEF DESCRIPTION OF THE DRAWINGS

Embodiments of invention may best be understood by referring to the following description and accompanying drawings that are used to illustrate embodiments of the invention. In the drawings:

FIG. 1 is a diagram illustrating a system in which one embodiment of the invention can be practiced.

FIG. 2 is a diagram illustrating a dental bleaching unit according to one embodiment of the invention.

FIG. 3 is a diagram illustrating a tray assembly according to one embodiment of the invention.

FIG. 4 is a diagram illustrating a mouthpiece according to one embodiment of the invention.

FIG. 5 is a diagram illustrating an attachment according to one embodiment of the invention.

FIG. 6 is a diagram illustrating a power source according to one embodiment of the invention.

FIG. 7 is a flowchart illustrating a process to use a dental bleaching unit according to one embodiment of the invention.

### DESCRIPTION

An embodiment of the present invention is a technique for dental bleaching. A tray covers teeth of a user and has a reservoir. A conductor is placed inside the tray. The conductor is covered by a bleaching agent when the bleaching agent fills the reservoir. The conductor is electrically connected to a negative terminal of a power source to cause regeneration of free radicals decomposed from the bleaching agent when power is applied.

In the following description, numerous specific details are set forth. However, it is understood that embodiments of the invention may be practiced without these specific details. In other instances, well-known circuits, structures, and techniques have not been shown to avoid obscuring the understanding of this description.

One embodiment of the invention may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a program, a procedure, a method of manufacturing or fabrication, etc.

One embodiment of the invention is a technique for dental bleaching or teeth whitening. The technique uses ionophoresis with peroxide to cause recycling or regeneration of decomposed ions or free radicals of a chemical agent in the bleaching agent, substance, or gel. Ionophoresis helps increase the absorption rate and depth. By recycling the free radicals, the bleaching process becomes fast, efficient, or requires little amount of bleaching agent, or does not require renew or reapply additional bleaching agent, substance, or gel.

The dental bleaching using ionophoresis is further enhanced by using additional processes to accelerate the decomposition of the free radicals. This may include using light emitting elements to generate light directed to the teeth covered by the bleaching agent at a proper wavelength. The bleaching agent may contain a photo chemical initiator (e.g., camphor quinone). At a proper wavelength (e.g., 465 nanometers), the light activates the initiator that produces energy to break down the peroxide in the bleaching agent. The light emitting elements are mounted in a mouthpiece that is applied to the inside of the mouth of the user. In addition, a heat generating element may be mounted in the mouthpiece to generate heat at a proper temperature range (e.g., 40° C. to 50° C.) when power is applied. The generated heat further accelerates the decomposition of free radicals. Lastly, the bleaching agent is filled in a reservoir of a tray which forms a sealed environment covering the teeth. The tray is made of plastic and is fitted to enclose the teeth.

One embodiment of the invention is a dental bleaching unit that offers at least of the following advantages: (1) high efficiency, (2) increased osmotic absorption, (3) high safety, (4) convenience to user. The high efficiency is achieved due to one or more of the following features: (a) recycling or regeneration of peroxide or oxygen with ionophoresis, (b) synergistical use of any combination of ionophoresis, intra-oral light, heat, and sealed environment, (c) placement of mouthpiece and tray assembly inside the user's mouth.

The bleaching agent, substance, or gel may include a chemical compound or material that may be decomposed into the following elements: OH—, HOO—, H+, H₂O, O—, and O₂. Examples of these chemical materials are hydrogen peroxide, carbamide peroxide, chloride dioxide, sodium perborate, or sodium percarbonate. The ionization of H₂O₂ (or HOOH) may produce hydroxyl ions (OH—), perhydroxyl ions (HOO—), hydrogen ions (H+), water (H₂O) and oxygen ions (O—) according to any of the following chemical equations:
2H₂O₂->H₂O+O₂ (1)
HOOH->HO—+—OH (2)
HOOH->HOO—+H+ (3)
HOOH->HOH+O— (4)

These ions are free radicals which tend to be unstable and immediately seek an available target with which to react. These free radicals interact with large, long-chained, dark colored chromogenic molecules that cause discoloration of the teeth. The interactions break these large chromogenic molecules into smaller, shorter-chained, and lighter colored molecules which create a different optical structure, substantially restoring the original white color of the teeth.

When the bleaching gel is biased to a negative polarity of a power source, its pH is increased and it becomes alkaline. This pH increase favors the decomposition of H₂O₂ into free radicals. Due to ionopheresis, the user's teeth are positively charged through the body and the bleaching gel is negatively charged, creating a polarity gradient, increasing the osmotic absorption of negative ions OH—, HOO—, or O—. The ionophoresis is regenerative or recycling in that the peroxide and water are regenerated or recycled continuously during the bleaching process. The regenerative ionopheresis occurs at two levels as follows.

In the first level, OH— ions are generated according to the following chemical reaction:
2H₂O+2e−->H₂+2OH— (5)

H₂O may come from the bleaching gel, if a water-based gel is used, or also from the recycling of H₂O from the decomposition of hydrogen peroxide H₂O₂.

In the second level, cathodic reduction of oxygen regenerates according to one of the following chemical reactions:
O₂+2H₂O+2e−->H₂O₂+2OH— (6)
O₂+2H++2e−->H₂O₂ (7)

H₂O₂ and OH— ions then enter again in the bleaching process. O₂, H+, and H₂O come from the recycling of the elements that derive from the decomposition of hydrogen peroxide as in the above equations.

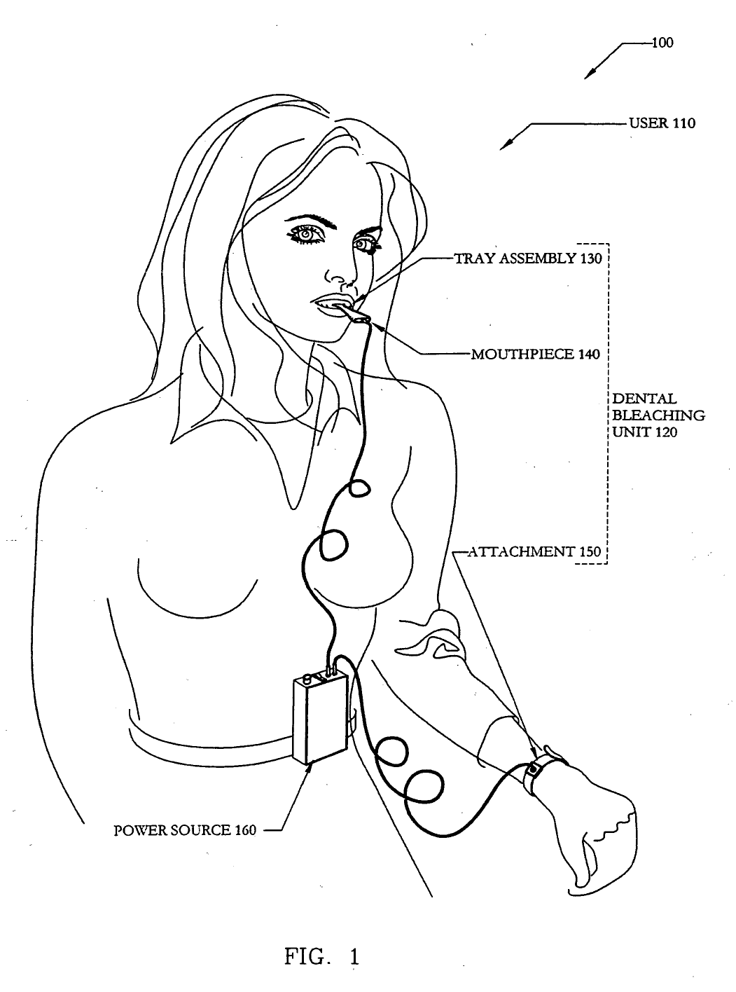

FIG. 1 is a diagram illustrating a system 100 in which one embodiment of the invention can be practiced. The system 100 includes a user 110, a dental bleaching unit 120, and a power source 160.

The user 110 is a person who uses the dental bleaching unit 120. She may wish to use the dental bleaching unit 120 to whiten her teeth. She may use the unit 120 at any convenient place such as at home, at a beauty salon, at a nail or hair salon, at work, in a waiting room of a doctor's office, or even at a dentist's office. She may use it while doing other things such as reading books, watching television, etc. The unit is easy to use and it may take only a short time to use it. The length of time may be anywhere from a few minutes to an hour. The unit may be purchased for home or office private use, or provided at the dental office, or provided as an extra service at other professional offices such as beauty salons, nail or hair salons, etc.

The dental bleaching unit 120 is used for dental bleaching or teeth whitening. It includes a tray assembly 130, a mouthpiece 140, and an attachment 150. Note that the dental bleaching unit 120 may include more or less of these components. For example, it may include only the tray assembly 130. In a typical scenario, the user 110 first fills the tray assembly with a bleaching agent and applies the tray assembly to cover her teeth. Then, the user 110 applies the mouthpiece 140 to the inside of her mouth. She may press the mouthpiece 140 against the tray assembly 130 and uses her lips to hold the mouthpiece 140 in place. In essence, the mouthpiece 140 is placed inside her mouth. She then attaches the attachment 150 to her body such as holding it in ner hand or wearing it around her wrist.

The power source 160 provides power to the dental bleaching unit 120. The power source may be powered by batteries. It has negative and positive terminals. It may include a power converter that converts alternating current (AC) to direct current (DC). Typically, two power supplies are provided to the dental bleaching unit 120. A first power supply provides approximately 6V to 12 V at 700 mA to power the light emitting elements and/or other electrical components in the mouthpiece 140. A second power supply provides approximately 6V to 12V at around 1 mA to provide electrolysis for the regenerative ionophoresis process. The power source 160 has wires, leads, or connections to connect to the dental bleaching unit 120 and the user 110. It may also have ON/OFF switch, control buttons, timer alarm, status indicator(s), and other interfacing components to allow the user or control or configure the bleaching process accordingly.

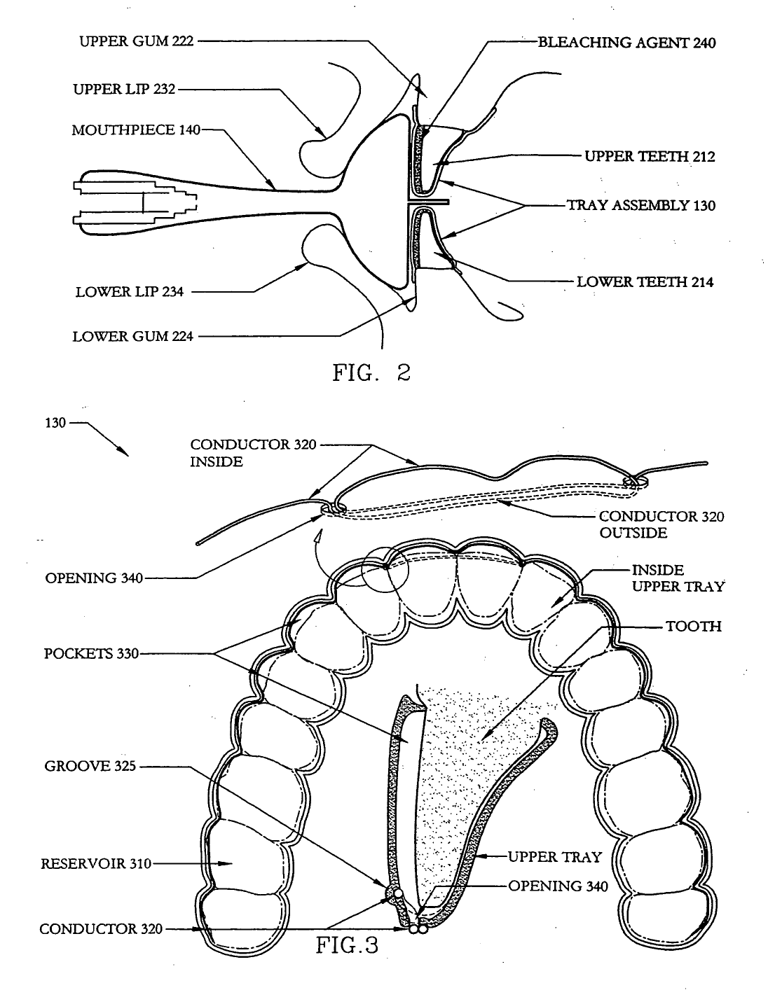

FIG. 2 is a diagram illustrating part of the dental bleaching unit 120 according to one embodiment of the invention. Part of the dental bleaching unit 120 may include the tray assembly 130 and the mouthpiece 140.

The tray assembly 130 may be any one used for upper teeth 212 and lower teeth 214. Typically two tray assemblies 130 are used for both upper teeth 212 and lower teeth 214 at the same time. The tray assembly 130 may cover several teeth both on the buccal and lingual surfaces of the teeth. It may also cover a portion of the gum, either the upper gum 222 or the lower gum 224 depending on whether it is used for the upper teeth 212 or the lower teeth 214, respectively. In other embodiments, the tray assembly may cover up to the gum line. It is filled with a bleaching agent, substance, or gel 240. The tray assembly 130 provides a sealed environment to contain the bleaching agent 240.

The bleaching agent 240 is a gel made of a compound including a chemical compound such as hydrogen peroxide, carbamide peroxide, chloride dioxide, sodium perborate, or sodium percarbonate. It may also include a photo chemical initiator (e.g., camphor quinone) that may be responsive to a wavelength (e.g., 465 nanometers). When illuminated by a light source at the desired wavelength, the photo initiator provides energy sufficiently to accelerate the decomposition of the hydrogen peroxide into ions or free radicals. The composition of the bleaching agent, substance, or gel 240 may be as follows: hydrogen peroxide: between 6% to 30%, camphor quinone: 2% to 5%.

The mouthpiece 140 is inserted inside the mouth of the user 110. It may be placed between the buccal surface of the teeth and the inside surface of the cheeks and lips of the user. It may be held firmly by the user's upper and lower lips 232 and 234. It may be pressed against the tray assemblies 130 to create a force or pressure on the tray assemblies 130, further sealing the bleaching agent 240 inside the tray assemblies 130. In addition, the mouthpiece 140 may form electrical contact between a conductor inside the tray assembly 130 and its internal electrical connections as will be explained later.

FIG. 3 is a diagram illustrating a tray assembly 130 according to one embodiment of the invention. The tray assembly 130 includes a reservoir 310, a conductor 320, and an opening 340. The tray assembly 130 may be made from a clear plastic sheet. It may be made from a model or a mold formed by impression on the user's dental structure or a pre-determined standard model.

The reservoir 310 is a hollow space formed by the curvature of the plastic sheet made of the tray assembly 130. The reservoir 310 may include a number of pockets 330. These pockets are formed to fit the individual teeth of a user either by impression or using a standard model. The pockets 330 may be pouches, sags, or compartments to contain the bleaching agent, substance, or gel when bleaching is performed. Along the pockets, there is a groove or a channel 325 that encloses the conductor 320. The groove 325 connects the pockets 330. The conductor 320 is placed inside the tray. It may be a wire running longitudinally along the bottom of the reservoir 310 through the groove 325. The groove 325 and the conductor 320 therein are located on the buccal side, or external surface of the teeth, and at the bottom of the pockets 330. When the tray assembly 130 is used for the upper teeth, the groove 325 and the conductor 320 appear at the bottom. When the tray assembly 130 is used for the lower teeth, it is turned upside down such that the groove 325 and the conductor 320 appear at the top. When both are used, it is therefore convenient to have a single contact element to make contact with both conductors since both conductors merge or converge to, or are located at, approximately the same location. The conductor is covered by, or immersed in, a bleaching agent when the bleaching agent fills the reservoir 310. It is electrically connected to a negative terminal of a power source via a contact element in the mouthpiece to cause regeneration of free radicals decomposed from the bleaching agent when power is applied. It is typically made of electrically conductive material such as gold, metal, or metallic alloy.

The opening 340 is a hole that exposes a contact point on the conductor 320 so that the conductor 320 may make a reliable contact with a contact element from the mouthpiece 140. The contact point may be designed to provide a hook or a lock that may snap on to a contact element when the contact element is pressed to the tray assembly 130. There may be more than one contact points on the conductor 320. In this case, the opening 340 may include a corresponding number of openings to expose these contact points. In one embodiment, the opening 340 includes two holes through which the conductor 320 exposes externally to form the contact point. The distance between the two holes and their location are selected to have reliable contact with the contact element. The conductor 320 may start from one end of the groove 325 near the last tooth and go though the first hole from inside out, then through the second hole from outside in. Then, it may go back to the first hole inside out and return to the second hole outside in to form a double loop at the contact location. Then, it may continue to the other end of the groove 325.

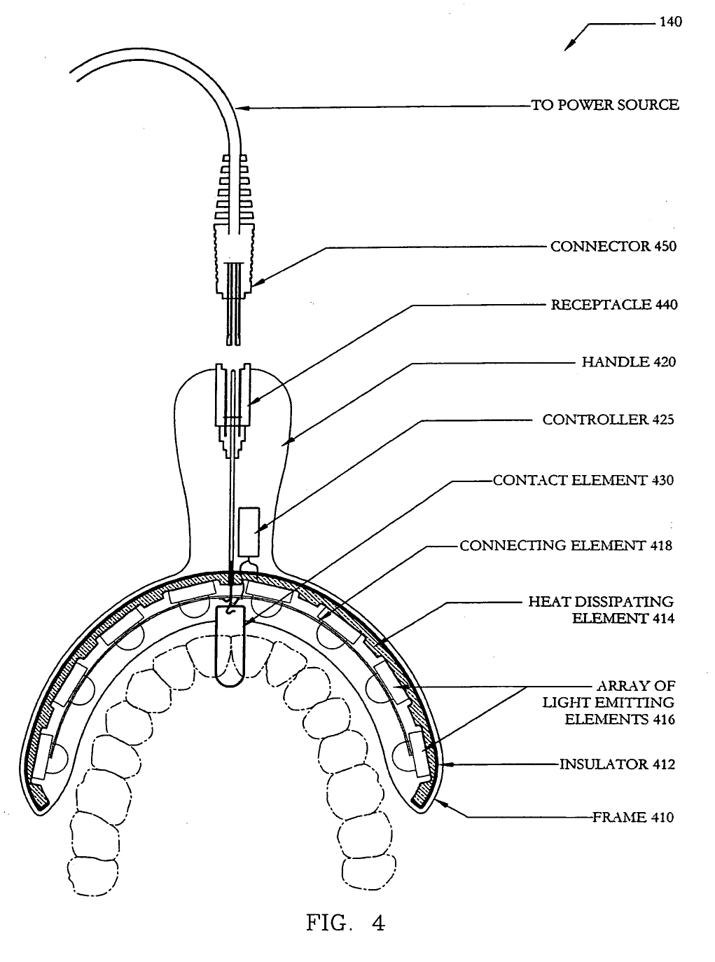

FIG. 4 is a diagram illustrating the mouthpiece 140 according to one embodiment of the invention. The mouthpiece 140 includes a frame 410, a handle 420, and a contact element 430.

The frame 410 has a horseshoe or U shape fitting dental arches on external side of the teeth. It may include an insulator layer 412, a heat dissipating element 414, an array 416 of light emitting elements, and a connecting element 418. The frame 410 may include more or less than the above elements. For example, it may not include the heat dissipating element 414, or it may not include the array 416 of light emitting elements. The frame 410 may include one or more sensors to sense one or more local environmental conditions such as temperature, humidity, or light to monitor these conditions inside the mouth of the user during the bleaching process. These sensors may be used to adjust or configure the dental bleaching unit accordingly, such as adjusting the heat, the light intensity, etc.

The insulator layer 412 is made of an insulating material to insulate heat or electricity for comfort and/or safety. The heat dissipating element 414 is mounted inside the frame 410. In one embodiment, the heat dissipating element 414 has electrical connections to the terminals of the power source to generate heat within a pre-defined temperature range when power is applied. This embodiment is typically used when there are no other heat generating elements in the unit, such as when the light emitting elements are not used. When the light emitting elements are used, heat generated by these elements may be sufficient to provide the heat for the unit. In this case, the heat dissipating element 414 is connected to the light emitting elements to extract or distribute the heat to other regions in the unit. Typically, the temperature range is approximately between 40° C. to 50° C.

The array 416 includes a number of light emitting elements, or light generating devices, mounted inside the frame 410. Typically, the light emitting elements are mounted on the center line of the frame 410 so that they may emit light equally to the upper and lower teeth. Since the mouthpiece 140 is placed inside the mouth and buccally to the jaws of the user, the light emitting elements are intra-oral, located close to the teeth. Therefore, the energy provided by the light interacting with the photo initiator may be efficiently produced. The light emitting elements have electrical connections to the terminals of the power source to generate light directed to the teeth of the user at a pre-defined wavelength when power is applied. The wavelength may range from 300 nm to 600 nm, or at any wavelength as necessary. In one embodiment, the light emitting elements are light-emitting diodes (LEDs) that emit light at a wavelength of approximately between 400 nm to 500 nm. In one embodiment, the light emitting elements may be selected to generate high light intensity and heat. The light color may be white or blue. The radiometric power may range from 140 mW to 600 mW. When high-powered light emitting elements are used, the heat dissipating element 414 may be simply connected to the base of these light emitting elements, or may not be needed.

The connecting element 418 connects the light emitting elements in the array 416. It may be a conductive wire or a collection of wires that are individually connected to the light emitting elements. The electrical connections to the light emitting elements may be such that all elements may be energized or individually energized when power is applied. The number of light emitting elements in the array 416 may depend on the number of teeth to be whitened. In one embodiment, the array 416 may have 6 to 12 light emitting elements. Additionally, the light emitting elements may be fixed or they may be moved or positioned by the user at desired locations on the surface of the frame 410 corresponding to the locations of the teeth to be whitened. There may be guides or rails mounted on the surface of the frame 410 to guide the movement of the light emitting elements.

The handle 420 allows the user 110 to hold or position the frame 410 at proper position when placing inside the mouth. It may be integral to the frame 410 or may be a separate component and attached to the frame 410. It may have a receptacle 440 that is fitted to receive a connector 450 that connect to the power source 160 (FIG. 1). The handle 420 may provide space to house electronic circuits for a number of control or monitor functions. It may house a controller 425. The controller 425 may provide a means to the user to control the level of bleaching or whitening. For example, the user may desire to perform bleaching or whitening on some selected teeth at a desired bleaching or whitening level to match the color of a crown or bridge, or other teeth. In these cases, excessive bleaching or whitening may not be desired because there may be non-uniformity in the overall color distribution of the teeth. The controller 425 may be coupled to the heat dissipating element 414 to adjust amount of the heat when generated by the heat dissipating element 414. It may be connected to a sensor located at the frame 410 to sense the temperature and adjust the amount of heat according to the desired temperature setting. It may also be connected to the array 416 to adjust the amount or intensity of light emitted by the light emitting elements. It may also provide control functions to selectively turn on or off the individual light emitting elements. There may be buttons located externally to the handle 420 to activate the control functions performed by the controller 425.

The contact element 430 may be located approximately at the center of the frame 410. It may be connected to the internal connections (e.g., the negative terminal of the power source) of the frame to make electrical contact with the conductor 320 when the frame 410 is pressed to the tray assembly 130. It may be a bite piece that may be held by the user. It is made of electrically conductive material (e.g., copper, stainless steel). It may be designed such that when the frame 410 is pressed against the tray assembly 130, it snaps or locks to the conductor 320 at a contact point through the opening 340. In one embodiment, the contact element 430 may include several pieces located along the longitudinal surface of the frame 410 to form multiple contacts with the conductor 320. In addition to providing electrical contact, the contact element 430 may also provide mechanical contact to firmly hold the frame 410 and the tray assembly 130 together. This may provide mechanical stability and/or support during the bleaching process.

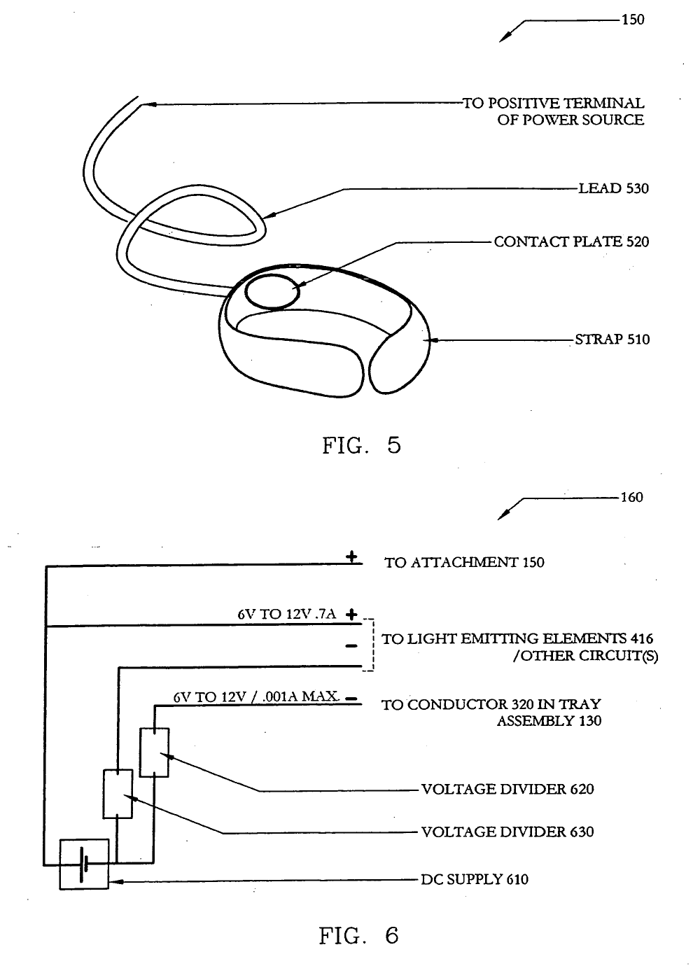

FIG. 5 is a diagram illustrating the attachment 150 according to one embodiment of the invention. The attachment 150 includes a strap 510, a contact plate 520, and lead 530.

The strap 510 may be of any convenient shape to provide an attachment to the user body. For example, it may be a plate, a handle, or a strip or a band that may be formed into a loop around the wrist of the user. It may be tightened or fastened by Velcro or any other fastening mechanism. The contact plate 520 provides contact to the user body or skin. It may be made of electrically conductive material such as gold or any suitable metal or alloy. It may be firmly attached to the strap 510 so that when the user fastens the strap 510 to her body or wrist, it makes a firm contact with the user skin. The contact plate 520 is connected to the lead 530 which is connected to the positive terminal of the power source 160.

When the user attaches the attachment 150 to her body and power is applied to start the bleaching process, the user's body is charged with positive current through the contact plate 520. At the same time the bleaching agent 240 is negatively charged through the conductor 320. Under this galvanic current, the free radicals decomposed from the hydrogen peroxide are drawn toward the positively charged tooth surface. In addition, recycling of H₂O₂ occurs, providing continuous supply of hydrogen peroxide during the bleaching process.

FIG. 6 is a diagram illustrating the power source 160 according to one embodiment of the invention. The power source 160 includes a direct current (DC) power supply 610, first and second voltage dividers 620 and 630. The power source 160 may include more or less than these components.

The DC power supply 610 may be a battery or batteries, rechargeable or non-rechargeable. It may also be an AC-to-DC converter that converts AC power from wall outlet to DC power. Typically, the voltage range is between 6V to 12V. The current may be up to 1A.

The first voltage divider 620 provides a suitable voltage to the electrolysis for the ionophoresis. It may include a current-limiting element to limit the current to a maximum pre-defined value. In one embodiment, the maximum galvanic current is approximately 1 mA. Similarly, the second voltage divider 630 provides a suitable voltage to the electrical components in the mouthpiece 140. These components may include the array 416 of the light emitting elements, the heat dissipating element 414, the controller 425, etc. In one embodiment, the voltage is in the range between 6V to 12 V, and the current ranges from 0.3A to 1A.

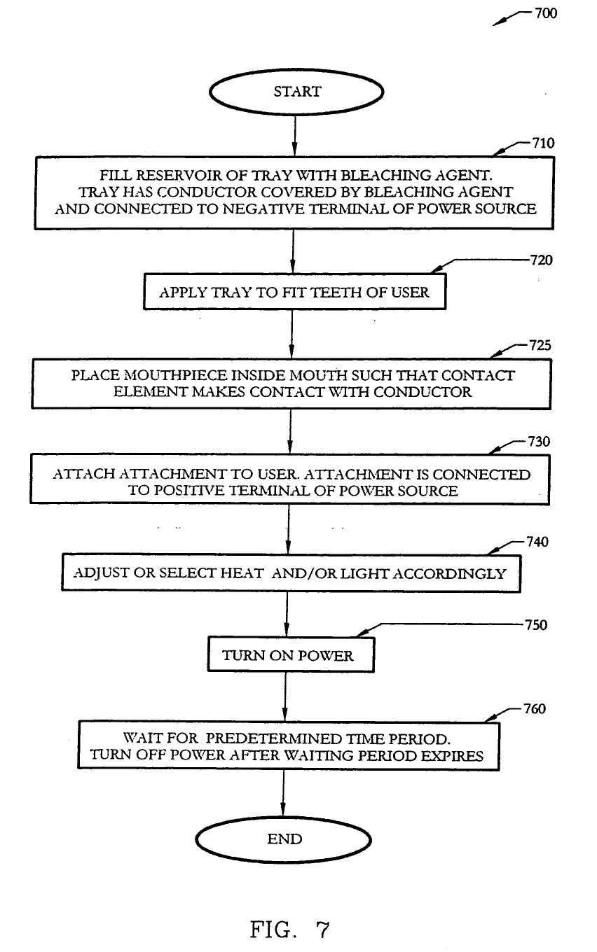

FIG. 7 is a flowchart illustrating a process 700 to use the dental bleaching unit according to one embodiment of the invention.

Upon START, the process 700 fills a reservoir of a tray with a bleaching agent, substance, or gel (Block 710). The tray has a conductor covered by the bleaching agent and connected to a negative terminal of a power source. The bleaching agent may contain one of hydrogen peroxide, carbamide peroxide, sodium perborate, and sodium percarbonate. The bleaching agent may decompose into at least one of OH—, HOO—, H+, H₂O, O—, and O₂ during the bleaching process. Next, the process 700 applies the tray to fit the teeth of the user (Block 720). If both upper teeth and lower teeth are bleached, then two trays or tray assemblies are used. Then, the process 700 places the mouthpiece into the mouth of the user (Block 725). The mouthpiece is positioned to align with the tray assembly/assemblies and is pressed against the tray assembly/assemblies such that the contact element of the mouthpiece makes contact with the conductor/conductors inside the tray assembly/assemblies.

Then, the process attaches an attachment to the user (Block 730). The attachment is connected to a positive terminal of the power source. This essentially positively charges the user body, including the user's teeth, when power is applied. Next, the process 700 adjusts the heat and/or light accordingly (Block 740). This may involve adjusting the variable power supply, or adjusting the control buttons to the controller.

Then, the process 700 turns on the power source (Block 750). Next, the process 700 waits for a pre-defined time period (Block 760). This time period may be a few minutes to an hour depending on several factors such as the type of bleaching agent, the desired bleaching level, the amount of heat to be generated, the number and/or type of light-emitting elements, etc. When the waiting time period expires, the process 700 turns off the power source and is then terminated.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

What is claimed is:

1. An apparatus comprising:
a tray to cover teeth of a user and having a reservoir; and
a conductor placed inside the tray, the conductor being covered by a bleaching agent when the bleaching agent fills the reservoir, the conductor being electrically connected to a negative terminal of a power source to cause regeneration of free radicals decomposed from the bleaching agent when power is applied.

2. The apparatus of claim 1 wherein the tray comprises:
a plurality of pockets that fit the teeth, the pockets forming the reservoir; and
a groove formed along the pockets to enclose the conductor.

3. The apparatus of claim 1 further comprising:
an attachment electrically connected to a positive terminal of the power source and attached to the user.

4. The apparatus of claim 1 wherein the tray is made of plastic.

5. The apparatus of claim 1 wherein the conductor is a wire made of a conductive material.

6. The apparatus of claim 3 wherein the attachment is a wrist holder that fits a wrist of the user.

7. The apparatus of claim 1 wherein the decomposition is regenerative.

8. A method comprising:
filling a reservoir of a tray with a bleaching agent, the tray being adapted to cover teeth of a user and having a conductor placed inside the tray, the conductor being covered by the bleaching agent and electrically connected to a negative terminal of a power source to cause regeneration of free radicals decomposed from the bleaching agent when power is applied;
applying the tray to fit the teeth of the user; and
attaching an attachment to the user, the attachment being electrically connected to a positive terminal of the power source.

9. The method of claim 8 wherein filling comprises:
filling the reservoir with the bleaching agent containing one of hydrogen peroxide, carbamide peroxide, chloride dioxide, sodium perborate, and sodium percarbonate.

10. The method of claim 8 wherein filling comprises:
filling the reservoir with the bleaching agent that decomposes into at least one of OH—, HOO—, H+, H₂O, O—, and O₂.

11. The method of claim 8 wherein applying comprises:
applying the tray having a plurality of pockets forming the reservoir such that the pockets fit the teeth.

12. The method of claim 8 wherein the tray is made of plastic.

13. The method of claim 8 wherein the conductor is a wire made of a conductive material.

14. The method of claim 8 wherein attaching comprises:
attaching the attachment being a wrist holder to a wrist of the user.

15. A dental bleaching unit comprising:
a mouthpiece to be applied inside of mouth of a user, the mouthpiece having connections to positive and negative terminals of a power source; and
a tray assembly to be pressed by the mouthpiece to teeth of the user comprising:
a tray to cover the teeth of the user and having a reservoir, and a conductor placed inside the tray, the conductor being covered by a bleaching agent when the bleaching agent fills the reservoir, the conductor being electrically connected to the negative terminal of the power source via the mouthpiece to cause regeneration of free radicals decomposed from the bleaching agent when power is applied.

16. The dental bleaching unit of claim 15 wherein the mouthpiece comprises:
a frame having a shape fitting dental arches on external side of the teeth.

17. The dental bleaching unit of claim 16 wherein the mouthpiece further comprises:
a heat dissipating element mounted inside the frame to dissipate heat within a pre-defined temperature range when power is applied.

18. The dental bleaching unit of claim 16 wherein the mouthpiece further comprises:
an array of light emitting elements mounted inside the frame having electrical connections to the terminals of the power source to generate light directed to the teeth of the user at a pre-defined wavelength when power is applied.

19. The dental bleaching unit of claim 16 wherein the mouthpiece further comprises:
a contact element connected to the connections to make electrical contact with the conductor when the frame is pressed to the tray assembly.

20. The dental bleaching unit of claim 16 wherein the mouthpiece further comprises:
a handle having an adaptor to couple to a receptacle having wires to connect to the terminals of the power source.

21. The dental bleaching unit of claim 17 wherein the mouthpiece further comprises:
a controller coupled to the heat dissipating element to adjust amount of the heat.

22. The dental bleaching unit of claim 18 wherein the mouthpiece further comprises:
a controller coupled to the array of the light emitting elements to adjust amount of the light.

23. The dental bleaching unit of claim 18 wherein the mouthpiece further comprises:
a controller coupled to the array of the light emitting elements to selectively turn on or off one or more of the light emitting elements.

24. The dental bleaching unit of claim 1 wherein the tray comprises:
a plurality of pockets that fit the teeth, the pockets forming the reservoir; and
a groove formed along the pockets to enclose the conductor.

25. The dental bleaching unit of claim 15 further comprising:
an attachment electrically connected to the positive terminal of the power source.

26. The dental bleaching unit of claim 15 wherein the tray is made of plastic.

27. The dental bleaching unit of claim 15 wherein the conductor is a wire made of a conductive material.

28. The dental bleaching unit of claim 25 wherein the attachment is a wrist holder that fits a wrist of the user.

29. The dental bleaching unit of claim 15 wherein the decomposition is regenerative.
